(19) United States
(12) Patent Application Publication
(10) Pub. No.: US 2009/0303147 A1
(43) Pub. Date: Dec. 10, 2009

(54) SECTORIZED, MILLIMETER-WAVE ANTENNA ARRAYS WITH OPTIMIZABLE BEAM COVERAGE FOR WIRELESS NETWORK APPLICATIONS

(75) Inventor: Debabani Choudhury, Thousand Oaks, CA (US)

Correspondence Address: DAVID A. SCOTT, P.O. BOX 71, KAMUELA, HI, 96743-0071, US

(73) Assignee: Intel Corporation, Santa Clara, CA (US)

(21) Appl. No.: 12/135,631

(22) Filed: Jun. 9, 2008

(51) Int. Cl. H01Q 13/02; H01P 11/00

(52) U.S. Cl. 343/776; 29/600; 343/786

(57) ABSTRACT

Planar, sectorized, millimeter-wave antenna arrays may include one or more of housings of dielectric material, such as split-blocks of a plastic material, having metallized plastic horns and waveguides formed, etched, and/or cut therein, waveguide-to-planar-transmission-line transition devices and planar structures embedded therein, and one or more integrated circuits coupled thereto.

### BACKGROUND

### Background

A band of radio frequencies between 30 Giga Hertz (GHz) and 300 GHz is known as an extremely high frequency (EHF) band. EHF radio signals have wavelengths between ten and one millimeter, and are thus referred to as millimeter wave signals. The relatively small wavelengths allow EHF signals to be radiated and received with relatively small antennas.

EHF band signals are generally more prone to atmospheric attenuation than lower frequency radio signals. While this reduces potential communication range, it also allows for smaller frequency reuse distances compared to lower frequency radio signals. The smaller reuse distance allows greater densities of transmitters and receivers within an area. Different wireless usage models at millimeter wavelengths require directional antennas with relatively high-gain and low-cost. Potential uses of EHF band radio signals include wireless personal area networks (WPAN).

### BRIEF DESCRIPTION OF THE DRAWINGS/FIGURES

FIG. 1 is a cross-sectional view of an antenna system with an integrated circuit.

FIG. 2 is a perspective view of a rectangular horn with split-block structure.

FIG. 3 is another perspective view of a rectangular horn with split-block structure.

FIG. 4 is a perspective view of a diagonal horn using split block structure.

FIG. 5 is another perspective view of a diagonal horn using split block structure.

FIG. 6 is a perspective view of a conical horn with split-block structure.

FIG. 7 is another perspective view of a conical horn with split-block structure.

FIG. 8 is a perspective view of an array of horns.

FIG. 9 is a perspective view of a row of horns arranged in a substantially semi- circular configuration.

FIG. 10 is a perspective view of a row of horns arranged in a substantially circular configuration.

FIG. 11 is a perspective view of multiple rows of horns arranged in substantially circular configurations.

FIG. 12 is another cross-sectional view of an antenna system.

FIG. 13 is another cross-sectional view of an antenna system.

FIG. 14 is an elevated perspective view of an antenna system.

In the drawings, the leftmost digit(s) of a reference number identifies the drawing in which the reference number first appears.

### DETAILED DESCRIPTION

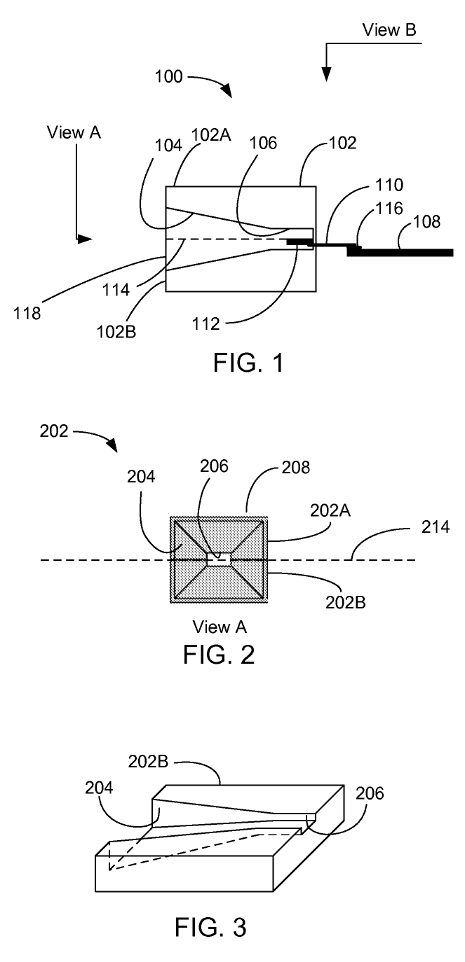

FIG. 1 is a cross-sectional view of an antenna system 100, including a housing 102, having a cavity therein, including a horn portion 104 and a waveguide portion 106, together referred to herein as a horn.

Housing 102 may include a dielectric material, such a plastic-based material, and a surface of the cavity within housing 102 may be coated with an electrically conductive material, such as a metal. Such an embodiment is referred to herein as metallized plastic.

Housing 102 may be assembled from split-blocks 102A and 102B, along a seam 114. Horn portion 104 and waveguide portion 106 may be formed, etched, and/or cut in split-blocks 102A and 102B prior to assembly. Where split-blocks 102A and 102B are made of a dielectric material, metallization of horn portion 104 and waveguide portion 106 may be performed prior to assembly and/or following assembly of split-blocks 102A and 102B.

Horn portion 104 and waveguide portion 106 may be sized and shaped to radiate and/or receive relatively high frequency radio signals, such as in the EHF band, including, without limitation, radio signals in a range near 60 GHz.

Such relatively high frequency signals, and correspondingly relatively short millimeter wavelengths, correspond to relatively small horns. Accordingly, antenna system 100 may include multiple horns in a relatively small package size. Multiple horns may be arranged in one or more of a variety of configurations to provide, for example, sectorized coverage over one or more desired azimuth ranges, in one or more planes for different usage models. Such horns may be configured as high-gain directional antenna systems in, for example, wireless personal area network (WPAN) type applications, at relatively low-cost. Exemplary configurations are disclosed below.

In a multiple horn antenna system, housing 102 may include, and be assembled from, a plurality of housing portions, each including one or more horns. The multiple housing portions may include split-block housing portions.

Housing 102 and cavities therein may be formed with one or more of a variety of conventional plastic fabrication processes, such as a relatively low-cost injection molding process. The cavities may be metallized using one or more of a variety of conventional metallization techniques. Alternatively, a metal horn and waveguide may be inserted into the cavities.

Housing 102, or a portion thereof, may be implemented with a metal material. For example, housing 102, and a cavity therein, may be formed with one or more of a variety of conventional plastic fabrication processes, as described above, and a metal horn and waveguide may be inserted into the cavity.

Antenna system 100 may be implemented as part of a wireless communications system for computer/mobile internet device (MID) network systems, such as access points, set-top-boxes, mobile-internet devices (MID), ultra-mobile personal computers (UMPCs), laptop computers, note-book computers, note-pad computers, and various hand-held communications devices, including telephones and personal digital assistants. Antenna system 100 may be configured to operate in a wireless personal area network (WPAN).

Antenna system 100 may include one or more integrated circuits, illustrated in FIG. 1 as integrated circuit 108, mounted to and/or within housing 102, and/or mounted to a platform or substrate to which housing 102 is mounted. Integrated circuit 108 may include receiver, transmitter, transceiver, baseband processing, and/or other circuitry.

For example, integrated circuit 108 may include frequency conversion circuitry to translate a modulated carrier signal between a relatively higher frequency (e.g., 60 GHz range) signal and one or more intermediate frequencies. The frequency translation circuitry may include one or more of a variety of integrated circuit topologies to translate between the higher frequency and a baseband frequency.

Integrated circuit 108 may include modulation and/or demodulation circuitry to modulate and/or demodulate signals to be radiated from horn portion 104 and/or received from horn portion 104.

Integrated circuit 108 may include baseband processing circuitry, including analog and/or digital baseband processing circuitry.

Integrated circuit 108 may me implemented with relatively low-cost, complimentary metal-oxide-semiconductor (CMOS) material and technology, with relatively high-volume manufacturing (HVM) capabilities.

Antenna system 100 may include one or more heat sinks mounted to and/or embedded within housing 102 to dissipate heat from integrated circuit 108.

Antenna system 100 may include a coupling system 110 to couple power from a contact 116 of integrated circuit 108 to wave-guide portion 106. Coupling system 110 may include a planar transmission line 110, which may include one or more of a microstrip, coplanar waveguide (CPW), grounded coplanar waveguide (GCPW), and/or suspended substrate lines. Coupling system 110 may include a probe 112, such as an E-field probe or other suitable device inserted within wave-guide portion 106 to optimize power transfer. Probe 112 may include microstrip, CPW or other suitable structures.

Contacts 116 may include controlled collapse chip connections (C4). C4 connections are solder bumps deposited on chip pads on a top side of an integrated circuit wafer or chip. The chip is flipped over for mounting so that the solder bumps face downward towards a mounting area. The solder bumps may be connected directly to external circuitry, such as coupling system 110. Such an integrated circuit is referred to as a flip-chip.

One or more horn portions 104 and waveguide portions 106 may be implemented in one or more of a variety of shapes, sizes, and configurations. For example, and without limitation, an opening 118 of horn portion 104 may have a circular shape, including oval, elliptical, and/or oblong, and/or or a polygonal shape, such as a square, rectangle, triangle, pentagon, hexagon, or octagon. Opening 118 may have a symmetrical or non-symmetrical shape. Surfaces of horn portion 104 and/or waveguide portion 106 may include one or more conical and/or polygonal shapes. Circular and polygonal shapes are relatively inexpensive to form, etch, mold, and/or cut in dielectric materials, such as plastic-based materials.

FIG. 2 is a perspective view, corresponding to view A in FIG. 1, of an exemplary housing 202, including a horn portion 204 and waveguide portion 206. Horn portion 204 includes a substantially rectangular opening 208, and a plurality of polygonal patterns, illustrated here as four-sided polygons. Housing 202 may include, and be assembled from split blocks 202A and 202B, along a seam 214. FIG. 3 is a perspective view of split block 202B, including horn portion 204 and waveguide portion 206 formed, etched, and/or cut therein.

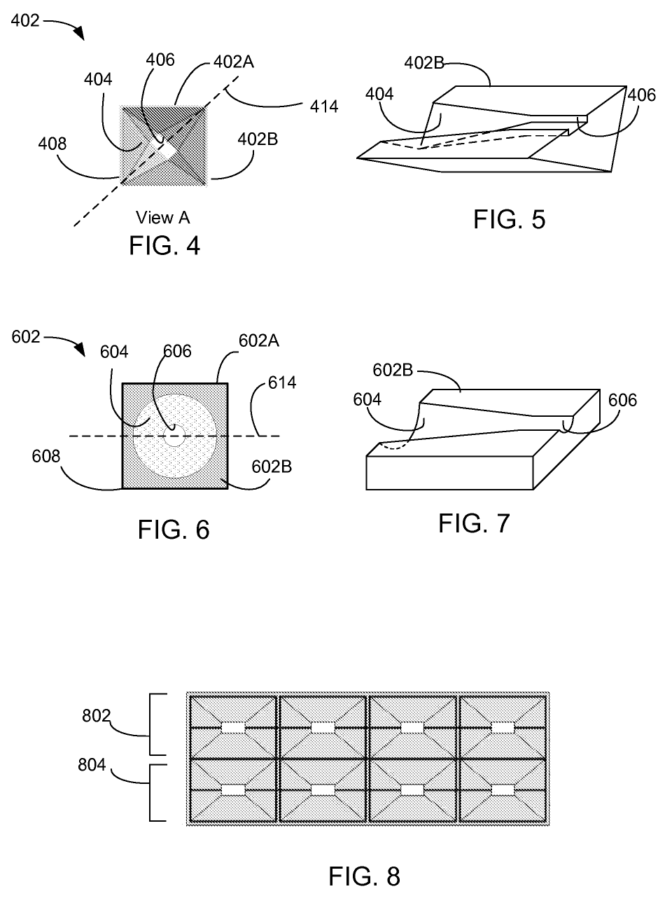

FIG. 4 is a perspective view, corresponding to view A in FIG. 1, of an exemplary housing 402, including a horn portion 404 and waveguide portion 406. Horn portion 404 includes a substantially rectangular opening 408, and a plurality of polygonal patterns, illustrated here as triangles. Housing 402 may include, and be assembled from split blocks 402A and 402B, along a seam 414. FIG. 5 is a perspective view of split block 402B, including horn portion 404 and waveguide portion 406 formed, etched, and/or cut therein.

FIG. 6 is a perspective view, corresponding to view A in FIG. 1, of an exemplary housing 602, including a horn portion 604 and waveguide portion 606. Horn portion 604 includes a substantially circular opening 608. Housing 602 may include, and be assembled from split blocks 602A and 602B, along a seam 614. FIG. 7 is a perspective view of split block 602B, including a conically shaped horn portion 604, and cylindrically shaped waveguide portion 606 formed, etched, and/or cut therein. Alternatively, waveguide portion 606 may be implemented with a rectangular cross-section.

Multiple horns may be arranged horizontally, vertically, and/or diagonally, relative to a plane, in a straight line and/or other configurations to obtain coverage over one or more desired azimuth sectors in one or more planes. Exemplary arrangements are disclosed below.

FIG. 8 is a perspective view of an array of horns, including a first row of horns 802 in a first plane, and a second row of horns 804 in a second plane.

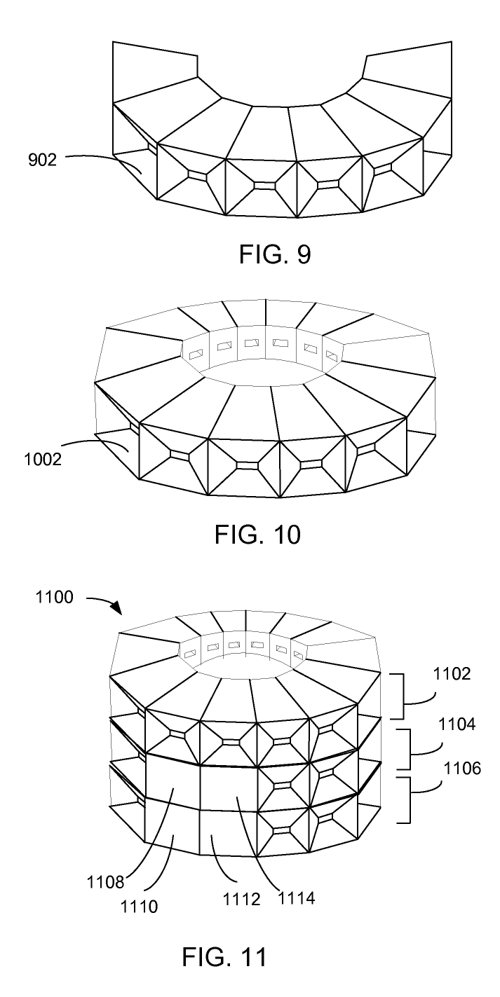

FIG. 9 is a perspective view of a row of horns 902 arranged in a substantially semi-circular configuration within a plane, to provide coverage over approximately 180 degrees of azimuth angles within the plane.

FIG. 10 is a perspective view of a row of horns 1002 arranged in a substantially circular configuration within a plane, to provide coverage over approximately 360 degrees of azimuth angles within the plane.

FIG. 11 is a perspective view of multiple rows of horns 1102, 1104, and 1106, each arranged in a substantially circular configuration in a corresponding plane.

Horns may be positioned adjacent to one another, and/or may be spaced apart from one another to provide a desired beam pattern, as illustrated by spacers 1108, 1110, 1112, and 1114, in FIG. 11. Spacers may implemented with one or more of horns that are not coupled to a transceiver, horns that are coupled to a transceiver but not actively in use by the transceiver, and/or a substantially solid dielectric material, such as a plastic material.

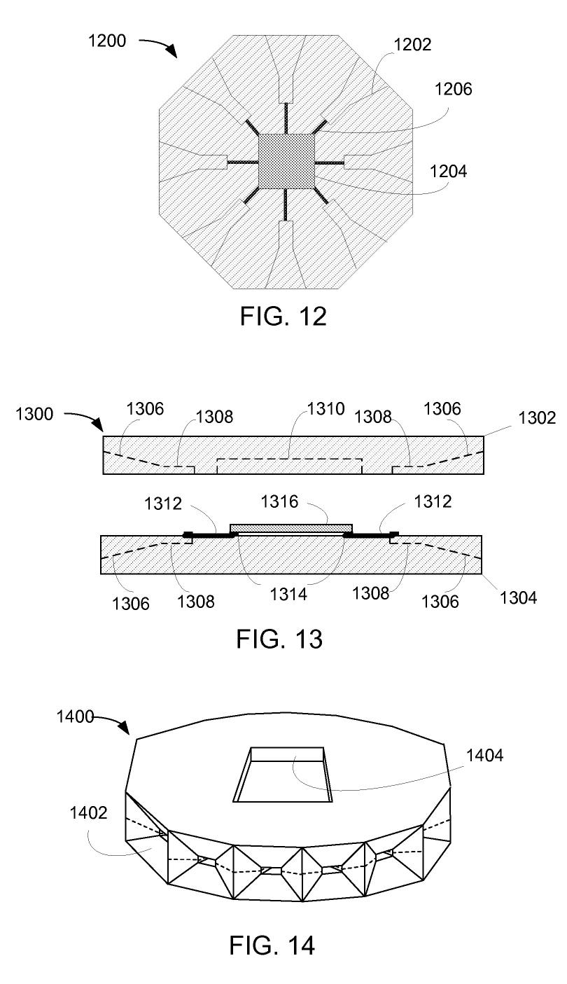

FIG. 12 is a cross-sectional view of an exemplary antenna system 1200, including a plurality of horns 1202 arranged in a substantially circular fashion, and an integrated circuit 1204 coupled to horns 1202 by corresponding coupling systems 1206. Coupling systems 1206 may be configured substantially identical to one another, and routed to minimize transmission losses and/or to optimize impedance matching. Integrated circuit 1204 may include C4 contacts, as described above with respect to FIG. 1, positioned to coincide with coupling systems 1206. Integrated circuit 1204 may be embedded within system 1200, as described below with reference to FIG. 13, and/or mounted to a surface thereof, as described below with reference to FIG. 14.

FIG. 13 is a cross-sectional side view of an antenna system 1300, including a first and second split blocks 1302 and 1304, respectively, which may be metallized plastic split blocks. Split block 1302 includes an integrated circuit cavity 1310. Split block 1304 includes coupling systems 1312 to couple contacts 1314 of an integrated circuit 1316 to wave-guide portions 1308. Contacts 1314 may include C4 contacts as described above with respect to FIG. 1.

FIG. 14 is an elevated perspective view of an antenna system 1400, including a plurality of horns 1402, and an integrated circuit cavity 1404 within a surface thereof. Antenna system 1400 may include a coupling system embedded therein to couple one or more integrated circuits to horns 1402.

Computer simulated E-field plots of a metallized plastic implementation of a 2×4 horn array, excited at 60 GHz, indicate a coupling between adjacent horns of less than −35 dB. Three dimensional electromagnetic field simulation plots further indicate that antenna systems, as disclosed herein, are relatively highly directional.

Methods and systems are disclosed herein with the aid of functional building blocks illustrating the functions, features, and relationships thereof. At least some of the boundaries of these functional building blocks have been arbitrarily defined herein for the convenience of the description. Alternate boundaries may be defined so long as the specified functions and relationships thereof are appropriately performed.

While various embodiments are disclosed herein, it should be understood that they have been presented by way of example only, and not limitation. It will be apparent to persons skilled in the relevant art that various changes in form and detail may be made therein without departing from the spirit and scope of the methods and systems disclosed herein.

What is claimed is:

1. A system, comprising:
a housing including a dielectric material having a plurality of metallized cavities therein including corresponding horn portions and waveguide portions having dimensions corresponding to millimeter-wavelength electromagnetic signals and directionally oriented to an azimuth sector of a plane; and
a plurality of planar transmission lines coupled between an integrated circuit area of the housing and corresponding ones of the waveguide portions.

2. The system of claim 1, wherein the housing comprises a split-block of a metallized plastic material.

3. The system of claim 1, wherein the horn portions include a polygon-shaped opening.

4. The system of claim 3, wherein the horn portions include a substantially rectangular opening.

5. The system of claim 1, wherein the horn portions include a one or more of a circular opening and an elliptical opening.

6. The system of claim 1, wherein the metallized cavities are directionally oriented to multiple azimuth sectors of the plane.

7. The system of claim 1, wherein at least a portion of the metallized cavities are directionally oriented to 360 degrees of the plane.

8. The system of claim 1, wherein the metallized cavities are directionally oriented to one or more azimuth sectors of multiple planes.

9. The system of claim 1, further comprising an integrated circuit mounted to the housing proximate to the integrated circuit area and coupled to the planar transmission lines.

10. A method, comprising:
manufacturing a housing from a dielectric material having a plurality of metallized cavities therein, the cavities including a horn portion and a waveguide portion dimensioned to radiate millimeter-wavelength electromagnetic signals, the manufacturing including directionally orienting the cavities to an azimuth sector of a plane; and
coupling a plurality of planar transmission lines between an integrated circuit area of the housing and corresponding ones of the waveguide portions.

11. The method of claim 10, wherein the manufacturing includes assembling the housing from a plurality of split-blocks of a plastic material.

12. The method of claim 10, wherein the manufacturing includes injection molding the housing and metallizing the cavities.

13. The method of claim 10, wherein the manufacturing includes directionally orienting the cavities to multiple azimuth sectors of the plane.

14. The method of claim 10, wherein the manufacturing includes directionally orienting the cavities to substantially 360 degrees of the plane.

15. The method of claim 10, wherein the manufacturing includes directionally orienting the cavities to one or more azimuth sectors of multiple planes.

16. The method of claim 11, further comprising mounting an integrated circuit to the housing proximate to the integrated circuit area and coupling the planar transmission lines to the integrated circuit.
